(19) United States
(12) Patent Application Publication
(10) Pub. No.: US 2005/0140953 A1
(43) Pub. Date: Jun. 30, 2005

(54) Image enhancement of substantially coherent imaging systems

(76) Inventor: David Scheiner, Yehuda (IL)

Correspondence Address: BROWDY AND NEIMARK, P.L.L.C.;624 NINTH STREET, NW, SUITE 300, WASHINGTON, DC, 20001-5303, US

(21) Appl. No.: 10/500,631

(22) PCT Filed: Jan. 5, 2003
(86) PCT No.: PCT/IL03/00013

(30) Foreign Application Priority Data
Jan. 3, 2002 (IL) 147473

(51) Int. Cl. G03B 27/52

(52) U.S. Cl. 355/55; 356/601

(57) ABSTRACT

A method of imaging a patterned sample comprising acquiring at least one image of the sample by illuminating the sample through an optical arrangement and collecting light reflected from the sample through said optical arrangement, wherein the optical arrangement has a predetermined numerical aperture NA and is located a predetermined distance from the sample. This predetermined distance being offset from a focal distance by an effective Talbot distance multiplied by a predetermined coefficient, the method thereby improving a smoothness of the image of the sample.

### FIELD OF THE INVENTION

This invention is in the field of optical monitoring techniques, and particularly relates to a method of imaging patterned structures. The invention is particularly useful in the manufacture of semiconductor devices.

### BACKGROUND OF THE INVENTION

Techniques for imaging patterned structures have been developed. The term “patterned structure” used herein, signifies a structure formed with regions having different optical properties with respect to an incident radiation. Optical inspection and metrology systems using imaging can be based on coherent or incoherent illumination. Systems for spatial analysis of surfaces can be based on scanning spot image generation or on imaging of the required field of view. In order do achieve artifact-free coherent imaging good spatial filtering of the light source is required This reduces speckle effects due to the light source. In addition, artifacts are caused by numerical aperture (NA) limitations. A finite numerical aperture has the effect of a low-pass filter on the spatial frequencies of the image. This causes oscillatory edge-ringing effects in the image (also known as the Gibbs effect) due to the effect of convolution of the Fourier transform of the system aperture with the image. This effect is directly related to the size of the NA of the system.

### SUMMARY OF THE INVENTION

It is a major object of the present invention to overcome the above listed and other disadvantages of the conventional imaging techniques and provide a novel method of imaging patterned structures.

According to one aspect of the present invention, there is provided a method for imaging of that enables improving a smoothness of the image of the sample, the method comprising acquiring at least one image of the sample by illuminating the sample with substantially coherent light through an optical arrangement and collecting light reflected from the sample through the optical arrangement The optical arrangement has a predetermined numerical aperture NA and is located a predetermined distance from the sample, said predetermined distance being offset from a focal distance by an effective Talbot distance multiplied by a predetermined coefficient, and effective Talbot distance being determined by the NA of the said optical arrangement.

Preferably, at least one image is acquired with the optical arrangement spaced from the sample at said predetermined distance being equal to +Zᵣ/4 or −Zᵣ/4, wherein Zᵣ is the effective Talbot distance.

Alternatively, an additional image of the sample is acquired, wherein a difference between locations of the optical arrangement from the sample during said one and said additional image acquiring being equal to Zᵣ/2, wherein Zᵣ is the effective Talbot distance, and averaging the two images, the image resulting from said average being thereby characterized by said higher smoothness.

Preferably, the additional image acquiring performs with optical arrangement located at focal distance from the sample.

According to another aspect of the present invention, there is provided a method comprising varying the distance of said optical arrangement from the sample during image formation through distance of at least Zᵣ/2 and preferably Zᵣ, thereby obtain an averaged image of higher smoothness than that of each of said several images.

Additionally, varying a numeral aperture NA of said optical arrangement, may bew performed and averaging the images to thereby obtain an averaged image of higher smoothness than that of each of said several images.

Additionally, the numerical aperture may be formed by different segments are place symmetrically about the optical axis, e.g. a star-like or a rectangular like shape.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is illustrated a low-pass effect of the limited NA of substantially coherent system;

FIG. 2 illustrates one-dimensional distribution of grey-level on an image of edge-like structure obtained at the output of the system due to low-pass effect of the limited NA;

FIGS. 3 and 4 illustrate a simulation of one-dimensional level-level distribution in image of edge-like and square island-like structures obtained in accordance with one embodiment of the present invention;

FIG. 5 illustrates a simulation of 3D distribution of grey-levels in case of a 20 micron square object imaged through a 0.25 NA system at wavelength of 800 nm;

FIG. 6 illustrates the effect of smoothing the ringing effects within central region of the square as of FIG. 5 in accordance with the present invention;

FIG. 7 illustrates a simulation of one-dimensional level-level distribution in image of square like-like structures obtained in accordance with another embodiment of the present invention and;

FIGS. 8a and 8b illustrate a flow diagram of the main steps of a method according to the invention;

### DETAILED DESCRIPTION OF A PREFERRED EMBODIMENT

In accordance with the present invention there are a number of techniques that enable reduction of the edge-ringing effects caused by the limitations of finite Numerical Aperture.

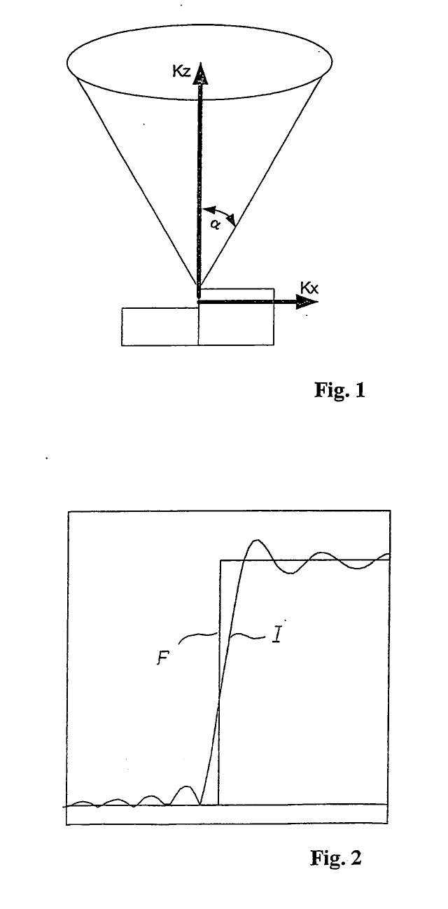

Referring to FIG. 1, there is illustrated a low-pass effect of the limited NA of a coherent system which removes high angle spatial frequencies from the image of the object. The limiting frequency Kₓ of the edge of the NA for a system with wavelength λ is as follows:
Kₖ=Kₒ*tgα≈2*π/λ*NA (1);

Wherein Kₒ is 2*π/λ, where λ is the optical wavelength and α is half the angular aperture.

The X-axis component G(X), at the object plane, of the Fourier transform of a square aperture is:
G(X)=1/(2*π)*sin(Kₓ*X)/(Kₓ*X) (2)
where G(X) is also the diffraction limited point spread function of the system. The image I(X) obtained at the output of the system is:
   I(X)=F(X)\mathring{×}G(X), (3)
where F is convolved with G. (See FIG. 2)

A finite aperture causes ringing adjacent to edges in the image, containing a pattern whose features are mainly due to the angular frequency that is missing from immediately outside the numerical aperture (See FIG. 2). The detailed characteristics of the ringing depend on the exact shape of the aperture. The result of the finite aperture is an oscillatory artifact in the image of pitch:
Pitch=2*π/Kx=λ/NA (4)

A well-known characteristic of periodic objects in optical systems is the self-imaging effect at out-of-focus conditions. This is known as the Talbot effect, which takes place near focus at distances within the Fresnel regime. The Talbot distance Zₜ associated with a pitch D for selected λ is as follows:
Zₜ=2*D²/λ (5)

Under defocus conditions an infinite grating undergoes self-imaging at defocus distances of n*Zₜ, where n is an integer. At offset distances of Zₜ/2 the image is a negative one, i.e. at distances of (n+½)*Zₜ. In the present case the effective Talbot distance Zᵣ associated with the ringing pitch is:
Zᵣ=2*D²/λ=2*λ/NA² (6)

The ringing undergoes an effect similar to self-imaging but with limitations caused by the finite extent of the ringing oscillations and the small higher spatial frequency content which is also present. At half Zᵣ distance this effect causes formation of an image with negative contrast oscillations. It should be noted that the negative contrast effect is more accurate further away from the edges that cause the oscillations. At the edge itself the “overshoot” of the intensity undergoes a lateral shift but does not change contrast. This overshoot is due to the central lobe of the aperture Fourier transform G(X); the lateral change of the overshoot is directly associated with the change in the diffraction limited point spread function of the system due to defocus.

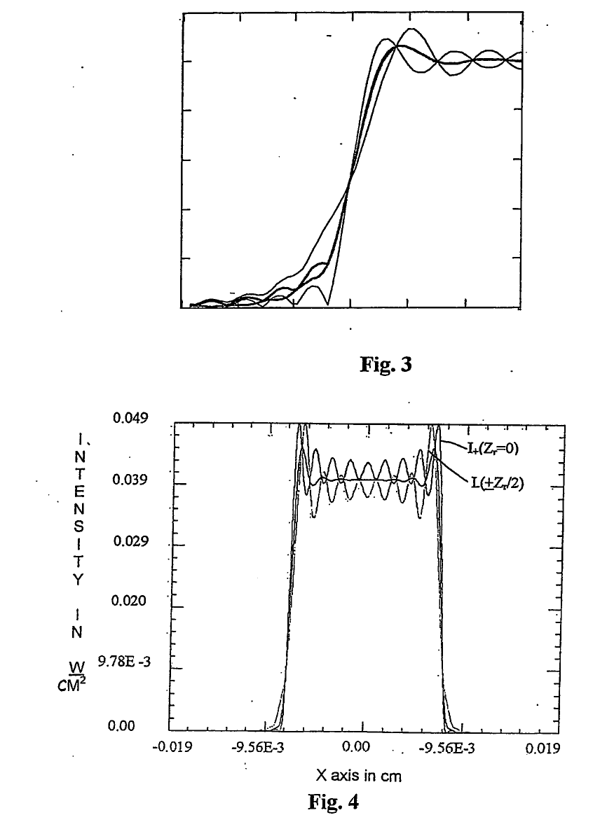

Reference is now made to FIGS. 3 and 4 illustrating a simulation of one-dimensional gray-level distribution in images of edge-like and square island-like structures obtained in accordance with one preferred embodiment of the present invention. In this case the negative contrast effect of averaging two images I₋ and I₊ taken at two different focal positions may be used in order to sufficiently decrease or even cancel out most of the ringing effects on the averaged image Iₐ. The images I₋ and I₊ could be added coherently or incoherently to achieve a similar effect. Moreover, this technique works for any two images taken with a relative defocus between them of Zᵣ/2, e.g. 0 and ±Zᵣ/2, −Zᵣ/6 and +Zᵣ/3 etc. Thus, the technique is applicable even in the case of inaccuracy in the initial focus, as long as the relative distance between the images is Zᵣ/2. Additionally, it is found that at a defocus of +Zᵣ/4 or −Zᵣ/4 from exact focus the image is intermediate between the two anti-phase ringing images. The image in this case is equivalent to the average of the two images at zero and Zᵣ/2 defocus.

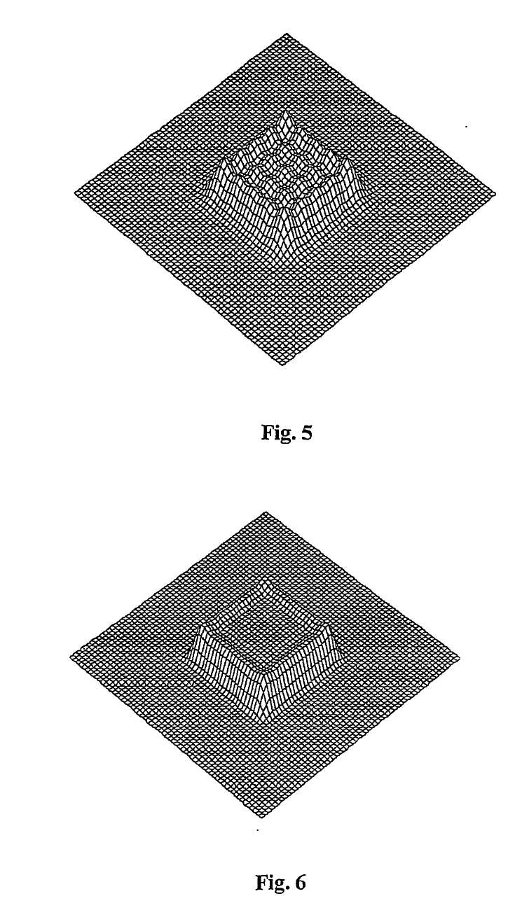

Reference is now made to FIG. 5 illustrating a simulation of 3D distribution of gray-levels in case of a 20 micron square object imaged through a 0.25 NA system at wavelength of 800 nm. The vertical axis of the 3D plot is the intensity at the image plane. FIG. 6 shows the effect of the averaging technique in smoothing the ringing effects within the central region of the square in accordance with the present invention.

The focal depth Z_{f} of a substantially coherent system is known in the literature to be:
Z_{f}=λ/2/NA² [symbol] (7)

Therefore the defocus required to smooth the ringing is of the order of the focal depth. In this case the diffraction limited point spread function of the system grows by a factor of order 2 in relation to the in-focus condition.

Another embodiment is for a system where the image is obtained from a CCD camera. Instead of capturing 2 images separately with different focus offset, it is possible to lengthen the exposure time of the CCD and scan the object through the focus region for a distance of at least Zᵣ/2 and preferably, about Zᵣ. This results in the required smoothing of the image without the need for additional image processing. It should be noted that the above description is applicable for any simple shape of finite aperture. The square aperture was chosen as an example.

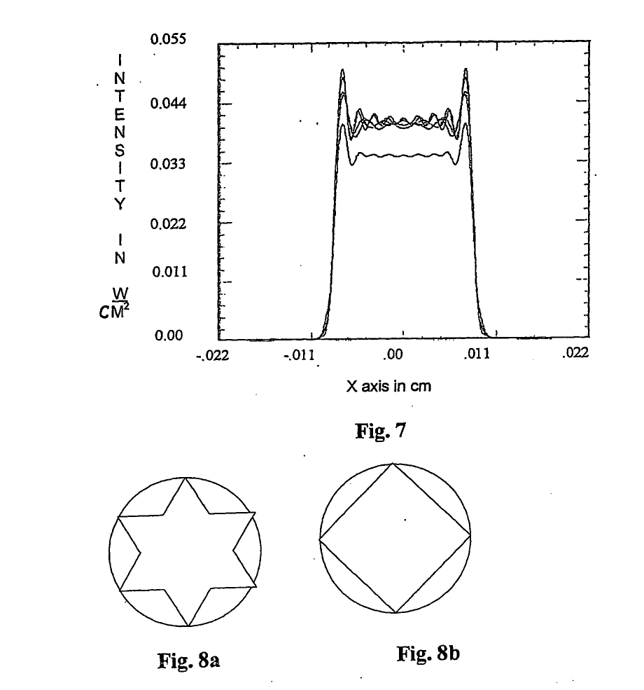

In accordance with another aspect of the present invention, an additional technique is based on variation of the NA of the system could be used. Different numerical apertures result in different typical ringing pitches. Averaging a series of images results in smoothing of the oscillations. Each image is averaged with weighting calculated from the specific NA. These images can be added coherently or incoherently to achieve a similar effect. The effect can be analyzed as a beating effect as follows. Reducing the NA so that the number of oscillations in a given area is reduced by one, results in an anti-phase condition at the center of the area. This second image in effect “cancels” the oscillation at the center of the area. Including an image with reduced NA such that the number of oscillations is reduce by two causes beating at two locations within the area in relation to the original image. In general, adding a series of images at reduced NA such that each one causes a smaller number of oscillations, gives a reduced level of ringing in the final image. In this case the penalty, in the form of reduced lateral resolution of the image due to the reduced NA, is larger than that of the images for the above defocus technique. This is due to the fact that for small areas the number of oscillations is small and the NA reduction steps are relatively large. For example a 35 micron wide stripe contains 7 oscillations when imaged through a NA=0.25 system at wavelength of 800 nm. In FIG. 7 five NA steps are averaged. The range of NA in this case is between 0.25 and 0.14. The result has been lowered by 15% in the graph for clarity.

Additionally, a similar NA effect could also be achieved, by shaping the aperture of the system to include segments of varying NA. The different segments are place symmetrically about the optical axis and the effective signals are inherently averaged coherently. For example a “flower-shaped” aperture can be used as shown in FIG. 5a. Another example (as illustrated in FIG. 5b) is useful for images that consist mainly of squares, rectangles and orthogonal lines along the main x-y axes of the optical system. In this case placing a square aperture rotated 45 degrees to the axis, results in reduced amplitude of the ringing.

The image itself can also be directly processed, based on the knowledge of the physical parameters of the system. For example, it can be spatially filtered with a notch filter of pitch: Pitch=λ/NA. An additional method can be to analyze a predefined calibration object with the system and record the edge response at the image. An inverse filter can be formed from this edge response and it can be used to process images to achieve reduction of the ringing as well as the overshoot effects at the edges. This calibration object can be analyzed separately and the edge response retained for later use or the predefined object can be included in the optical system and imaged concurrently with the object that the system is examining, preferably on the same imaging sensor, e.g. a CCD camera. In one embodiment the object under examination is imaged on part of the CCD device and the calibration object is imaged on another part of the CCD device.

Those skilled in the art will readily appreciate that many modifications and changes may be applied to the invention as hereinbefore exemplified without departing from its scope, as defined in and by the appended claims. For example, combination of both techniques of Image Enhancement may be performed in the method of substantially coherent imaging or incoherent imaging system.

1. A method of imaging a patterned sample, the method comprising acquiring at least one image of the sample by illuminating the sample with substantially coherent light through an optical arrangement and collecting light reflected from the sample through said optical arrangement, wherein said optical arrangement has a predetermined numerical aperture NA and is located a predetermined distance from the sample, said predetermined distance being offset from a focal distance by an effective Talbot distance Zᵣ multiplied by a predetermined coefficient, the method thereby improving a smoothness of the image of the sample, the effective Talbot distance being determined by the NA of the said optical arrangement.

2. The method according to claim 1, wherein said effective Talbot distance Zᵣ being determined as follows:
Zᵣ=2*λ/NA²;
wherein the NA numerical apertur of the said optical arrangement and λ is a wavelength of said illuminating light.

3. The method according to claim 1, wherein said at least one image is acquired with the optical arrangement spaced from the sample at said predetermined distance being equal to +Zᵣ/4 or −Zᵣ/4, wherein Zᵣ is the effective Talbot distance.

4. The method according to claim 2, wherein said at least one image is acquired with the optical arrangement spaced from the sample at said predetermined distance being equal to +Zᵣ/4 or −Zᵣ/4, wherein Zᵣ is the effective Talbot distance.

5. The method according to claim 1, comprising acquiring an additional image of the sample, wherein a difference between locations of the optical arrangement from the sample during said one and said additional image acquiring being equal to Zᵣ/2, wherein Zᵣ is the effective Talbot distance, and averaging the two images, the image resulting from said average being thereby characterized by said higher smoothness.

6. The method according to claim 2, comprising acquiring an additional image of the sample, wherein a difference between locations of the optical arrangement from the sample during said one and said additional image acquiring being equal to Zᵣ/2, wherein Zᵣ is the effective Talbot distance, and averaging the two images, the image resulting from said average being thereby characterized by said higher smoothness.

7. The method according to claim 5, wherein said additional image acquiring performs with optical arrangement located at focal distance from the sample.

8. The method according to claim 6, wherein said additional image acquiring performs with optical arrangement located at focal distance from the sample.

9. The method according to claim 5, further comprising varying the distance of said optical arrangement from the sample during image formation through distance of at least Zᵣ/2 to thereby obtain an averaged image of higher smoothness than that of each of said several images.

10. The method according to claim 5, further comprising varying the distance of said optical arrangement from the sample during image formation through distance of at least Zᵣ, to thereby obtain an averaged image of higher smoothness than that of each of said several images.

11. The method according to claim 6, further comprising varying the distance of said optical arrangement from the sample during image formation through distance of at least Zᵣ/2 to thereby obtain an averaged image of higher smoothness than that of each of said several images.

12. The method according to claim 6, further comprising varying the distance of said optical arrangement from the sample during image formation through distance of at least Zᵣ, to thereby obtain an averaged image of higher smoothness than that of each of said several images.

13. The method according to claim 1, further comprising varying a numeral aperture NA of said optical arrangement, and averaging the images to thereby obtain an averaged image of higher smoothness than that of each of said several images.

14. The method according to claim 1, further comprising a step of varying said numeral aperture NA of said optical arrangement, and averaging the images to thereby obtain an averaged image of higher smoothness than that of each of said several images.

15. The method according to claim 1, wherein said numerical aperture being formed by different segments are place symmetrically about the optical axis.

16. The method according to claim 15, wherein said numerical aperture being of a star-like shape.

17. The method according to claim 15, wherein said numerical aperture being of a rectangular like shape.

18. The method according to claim 13, further comprising a step of varying said numeral aperture NA of said optical arrangement, and averaging the images to thereby obtain an averaged image of higher smoothness than that of each of said several images.

19. The method according to claim 18, wherein said numerical aperture being formed by different segments are place symmetrically about the optical axis.

20. The method according to claim 19, wherein said numerical aperture being of a star-like shape.
